(19) United States
(12) Patent Application Publication
(10) Pub. No.: US 2026/0356632 A1
(43) Pub. Date: Nov. 12, 2026

(54) APPARATUS AND METHOD FOR MONITORING ELEVATOR CABIN, DOOR MOVEMENT, AND POSITION

(71) Applicant: TK Elevator Innovation and Operations GmbH, Düsseldorf (DE)

(72) Inventors: Eric Von DeShazer, Alpharetta, GA (US); Alison Powers, Atlanta, GA (US); Mark McCarthy, Marietta, GA (US)

(73) Assignee: TK Elevator Innovation and Operations GmbH, Düsseldorf (DE)

(21) Appl. No.: 19/125,920

(22) PCT Filed: Oct. 26, 2023
(86) PCT No.: PCT/EP2023/079926

§ 371 Date: Apr. 30, 2025

Related U.S. Application Data
(60) Provisional application No. 63/381,870, filed on Nov. 1, 2022.

(51) Int. Cl. B66B 5/00; B66B 1/34; B66B 13/02

(52) U.S. Cl. CPC B66B 5/0018; B66B 1/3461; B66B 1/3492; B66B 13/02

(57) ABSTRACT

A method for remotely determining a vertical position of an elevator cab and an elevator door movement of a door panel of the elevator cab in a hoistway including the steps of providing a gateway device coupled to an elevator cab, the gateway device having a processor, a signal processing and state computation hub device library, providing a sensor package assembly attached to the elevator cab, the sensor package assembly having an accelerometer sensor, measuring an acceleration of a movement of the door panel using the accelerometer sensor as a raw door data; converting the raw door data into at least one door movement state changes data; assembling the at least one door movement state changes data into a door movement event; and transmitting the door movement event to a cloud-based central data processing service device via a mobile wireless interface.

### CROSS REFERENCE TO RELATED APPLICATIONS

This application claims priority to the United States Provisional Patent Application Ser. No. 63/381,870, filed on Nov. 1, 2022, and entitled “Apparatus and Method For Monitoring Elevator Cabin, Door Movement, and Position” which is incorporated by reference herein in its entirety under 35 U.S.C. § 119(e).

### TECHNICAL FIELD

The present disclosure generally relates to elevator assemblies and, more particularly, to systems and methods for remotely determining and transmitting a door movement position and a position of an elevator cab in a hoistway.

### BACKGROUND

Determining an elevator position in a hoistway or a door position may be achieved using an accelerometer. However, due to the nature and construction of the hoistways and the elevator assembly itself, it is difficult to monitor, in real time, remotely from the elevator assembly, the current status and position of the elevator in the hoistway and the door positions.

There is therefore a need in the art for a structure and method to permit accurate, and real-time door movement positions and positions of the elevator cab in a hoistway.

### SUMMARY

In one aspect, there is disclosed a method for remotely determining a vertical position of an elevator cab and an elevator door movement of a door panel of the elevator cab in a hoistway. The method including the steps of providing a gateway device having a processor in the hoistway or in a machine room, the gateway device having a mobile wireless interface that is configured to transmit data to a cloud-based central data processing service device; providing a radio frequency module having a static barometer in the hoistway and communicatively coupled to the gateway device, the static barometer providing a raw static pressure; providing a gateway interface in the hoistway that is communicatively coupled to the radio frequency module; providing the elevator cab positioned in the hoistway; providing a signal processing and state computation hub device coupled to the elevator cab, the signal processing and state computation hub device including a dynamic barometer sensor and an accelerometer sensor or a time of flight sensor, the signal processing and state computation hub communicatively coupled to the gateway interface; measuring an acceleration data using the accelerometer sensor or a distance of movement of the door panel using the time of flight sensor for the elevator door movement of the elevator cab as a raw door data and a dynamic pressure from the dynamic barometer sensor as a raw dynamic pressure; converting the raw door data into at least one door movement state changes data; converting the acceleration data and the raw dynamic pressure into at least one cabin movement state changes data; transmitting the at least one door movement state changes data and the at least one cabin movement state changes data to the gateway device via the gateway interface; assembling the at least one door movement state changes data into a door movement event and the at least one cabin movement state changes data into a cabin movement event; and transmitting the door movement event and the cabin movement event to the cloud-based central data processing service device via the mobile wireless interface.

In another aspect, there is disclosed a method for remotely determining a vertical position of an elevator cab and an elevator door movement of a door panel of the elevator cab in a hoistway including the steps of providing the elevator cab positioned in the hoistway; providing a gateway device coupled to the elevator cab, the gateway device having a processor, a signal processing and state computation hub device library, and a mobile wireless interface that is configured to transmit data to a cloud-based central data processing service device; providing a sensor package assembly attached to the elevator cab, the sensor package assembly having an accelerometer sensor, the sensor package assembly communicatively coupled to the gateway device; measuring an acceleration of a movement of the door panel using the accelerometer sensor as a raw door data; converting the raw door data into at least one door movement state changes data; assembling the at least one door movement state changes data into a door movement event; and transmitting the door movement event to the cloud-based central data processing service device via the mobile wireless interface.

In yet another aspect there is disclosed an elevator system for remotely determining a vertical position of an elevator cab and an elevator door movement of a door panel of the elevator cab in a hoistway. The elevator system includes a sensor package assembly having an accelerometer sensor mounted to the elevator cab; a radio frequency module having a static barometer in the hoistway; a gateway device communicatively coupled to the radio frequency module; and a signal processing and state computation hub device coupled to the elevator cab and communicatively coupled to the sensor package assembly and to the gateway device, the signal processing and state computation hub device including a dynamic barometer sensor and a second accelerometer sensor, the signal processing and state computation hub device further having a processor and a non-transitory, processor-readable storage medium in communication with the processor comprising one or more programming instructions that, when executed, cause the processor to: measure an acceleration of the door panel as a raw door data using the accelerometer sensor, a dynamic pressure from the dynamic barometer sensor as a raw dynamic pressure and a cabin acceleration data detected from the second accelerometer sensor; convert the raw door data into at least one door movement state changes data; convert the cabin acceleration data and the raw dynamic pressure into at least one cabin movement state changes data; and transmit the at least one door movement state changes data and the at least one cabin movement state changes data to the gateway device. The gateway device includes a gateway processing device and a gateway non-transitory, processor-readable storage medium in communication with the processor and comprising one or more programming instructions that, when executed, cause the gateway processing device to: assemble the at least one door movement state changes data into a door movement event and the at least one cabin movement state changes data into a cabin movement event; and transmit the door movement event and the cabin movement event to a cloud-based central data processing service device via a mobile wireless interface.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 schematically depicts a first aspect of an example elevator assembly schematic according to one or more embodiments shown and described herein;

FIG. 2A schematically depicts an aspect of the example elevator assembly of FIG. 1 including a gateway device, a signal processing and state computation hub device, a sensor package assembly and a radio frequency module according to one or more embodiments shown and described herein;

FIG. 2B schematically depicts another aspect of the example elevator assembly of FIG. 1 including the gateway device, the signal processing and state computation hub device, the sensor package assembly and the radio frequency module according to one or more embodiments shown and described herein;

FIG. 2C schematically depicts another aspect of the example elevator assembly of FIG. 1 including the gateway device, the signal processing and state computation hub device, and the radio frequency module according to one or more embodiments shown and described herein;

FIG. 3 schematically depicts a second aspect of an example elevator assembly schematic according to one or more embodiments shown and described herein;

FIG. 4A schematically depicts an aspect of the example elevator assembly of FIG. 3 including a gateway device, a sensor package assembly, a radio frequency module, and a dynamic radio frequency module according to one or more embodiments shown and described herein;

FIG. 4B schematically depicts another aspect of the example elevator assembly of FIG. 3 including the gateway device, the sensor package assembly, the radio frequency module, and the dynamic radio frequency module according to one or more embodiments shown and described herein;

FIG. 5 schematically depicts a third aspect of an example elevator assembly schematic according to one or more embodiments shown and described herein;

FIG. 6 schematically depicts an aspect of the example elevator assembly of FIG. 5 including a gateway device and a sensor package assembly according to one or more embodiments shown and described herein;

FIG. 7 schematically depicts a fourth aspect of an example elevator assembly schematic according to one or more embodiments shown and described herein;

FIG. 8 schematically depicts an aspect of the example elevator assembly of FIG. 7 including a gateway device, a static sensor package assembly, a signal processing and state computation hub device, and a dynamic sensor package assembly according to one or more embodiments shown and described herein;

FIG. 9 schematically depicts a fifth aspect of an example elevator assembly schematic according to one or more embodiments shown and described herein;

FIG. 10 schematically depicts an aspect of the example elevator assembly of FIG. 9 including a gateway device, a static sensor package assembly, and a signal processing and state computation hub device according to one or more embodiments shown and described herein;

FIG. 11 schematically depicts a sixth aspect of an example elevator assembly schematic according to one or more embodiments shown and described herein;

FIG. 12A schematically depicts an aspect of the example elevator assembly of FIG. 11 including a gateway device, a sensor package assembly, and a signal processing and state computation hub device according to one or more embodiments shown and described herein;

FIG. 12B schematically depicts another aspect of the example elevator assembly of FIG. 11 including a gateway device, a sensor package assembly, and a signal processing and state computation hub device according to one or more embodiments shown and described herein;

FIG. 13 schematically depicts a flow diagram of an illustrative method for performing initial calibrations according to one or more embodiments described and illustrated herein;

FIG. 14 schematically depicts a flow diagram of an illustrative method for a standard operation of the aspect depicted in FIG. 2A according to one or more embodiments described and illustrated herein;

FIG. 15 schematically depicts a gateway device of FIG. 2A, further illustrating hardware and software components that may be used to transform, assemble and transmit specific data to remote locations offsite from the example elevator assembly according to one or more embodiments described and illustrated herein;

FIG. 16 schematically depicts a signal processing and state computation hub device of FIG. 2A, further illustrating hardware and software components that may be used to transform, generate data, and transmit specific data to other components of the example elevator assembly according to one or more embodiments described and illustrated herein;

FIG. 17 schematically depicts flow diagram of an illustrative method for pairing the radio frequency module with the various components of the example elevator assembly according to one or more embodiments described and illustrated herein; and

FIG. 18 schematically depicts flow diagram of an illustrative method for remotely monitoring the elevator cab position and door panels position using the various components of the example elevator assembly.

### DETAILED DESCRIPTION

Embodiments of the present disclosure are directed to improved systems and methods to monitor and identify a position of an elevator within a hoistway and//or door movements of door panel remotely from the elevator assembly. More specifically, the disclosed systems and methods provide an approach for improved position determination and door movements determinations without the need to have a technician on-site as well as provide for a wireless interface that eliminates the need to use conductors in the elevator traveling cable, simplifies installation, and reduces installation time.

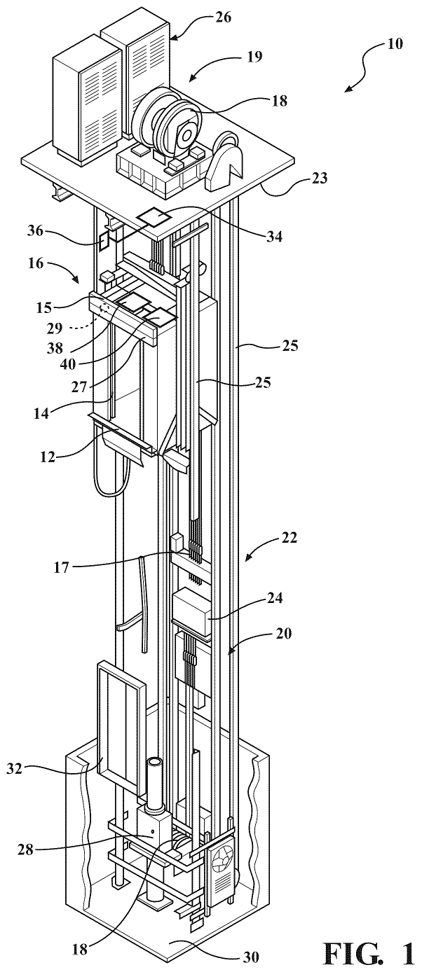

As used herein, the term “longitudinal direction” refers to the forward-rearward direction of the elevator assembly (i.e., in a +/−Y direction of the coordinate axes depicted in FIG. 1). The term “lateral direction” refers to the cross-direction (i.e., along the X axis of the coordinate axes depicted in FIG. 1), and is transverse to the longitudinal direction. The term “vertical direction” refers to the upward-downward direction of the elevator stabilizing assembly (i.e., in the +/−Z direction of the coordinate axes depicted in FIG. 1).

The phrase “communicatively coupled” is used herein to describe the interconnectivity of various components of the monitoring system for elevator assemblies and means that the components are connected either through wires, optical fibers, or wirelessly such that electrical, optical, data, and/or electromagnetic signals may be exchanged between the components. It should be understood that other means of connecting the various components of the system not specifically described herein are included without departing from the scope of the present disclosure.

Referring now to the drawings, FIG. 1 depicts an elevator assembly schematic that illustrates various components for a first aspect of an example elevator assembly 10. In this aspect, the example elevator assembly 10 may include an elevator cab 12, a plurality of elevator hoisting members 17 illustrated for schematic reasons as a single suspension member, a hoistway 16 or elevator shaft, a plurality of sheaves 18, a machine room 19, and a counterweight frame 22 that includes a plurality of weights 24 and in which is retained within the hoistway 16 that act as a counterweight to the elevator cab 12.

Further, in this aspect, as illustrated and without limitation, the example elevator assembly may include two sheaves of the plurality of sheaves 18. For example, one sheave is fixedly mounted to a rail cap 23 within the machine room 19 above the elevator cab 12 in a vertical direction (i.e., in the +/−Z direction) and another sheave is positioned near or coupled to a floor 30 of the hoistway 16. This is non-limiting, and any number of the plurality of sheaves 18 may be mounted anywhere within the hoistway 16 and/or in the machine room 19 and there may be more than or less than the two sheaves illustrated as being in the example elevator assembly 10.

At least one of the plurality of sheaves 18 may include a motor such that the sheave is a traction sheave capable of driving the plurality of elevator hoisting members 17 through a plurality of lengths between the elevator cab 12 and the traction sheave. Further, the plurality of sheaves 18 may further include a plurality of idler sheaves that may also be mounted at various positions in the hoistway 16 and/or in the machine room 19, and, in this aspect, are also coupled to the elevator cab 12. Idler sheaves are passive (they do not drive the elevator hoisting members 17, but rather guide or route the plurality of elevator hoisting members 17) and may also form a contact point, or engagement point, with the elevator cab 12. The plurality of sheaves 18 may include any combination of traction type sheaves and idler type sheaves. As such, the elevator cab 12 and the counterweight frame 22 move within the hoistway 16 in the system vertical direction (i.e., in the +/−Z direction) along a fixed member 20 that includes a pair of rails 25. The plurality of sheaves 18 along with the plurality of elevator hoisting members 17 move the elevator cab 12 between a plurality of positions within the hoistway 16 including to a plurality of landings 32 as well as move the counterweight frame 22.

The elevator cab 12 includes door panels 14 and a cabin roof 15. The door panels 14 are operated by and includes the necessary components for such as opening and closing the door panels 14 at the landings 32. For example, and without limitation, the operating components may include a closed loop door operator, car door hangers, arm driven, belt driven, and of course, operate at various speeds. The floor 30 may further include a car buffer 28 extending thereform. The machine room 19 may further include an elevator controller 26 configured to control the operation of all the components of the example elevator assembly 10. As such, the elevator controller 26 may include the necessary processors, logic modules, memory, data storage and the like to operate the example elevator assembly 10.

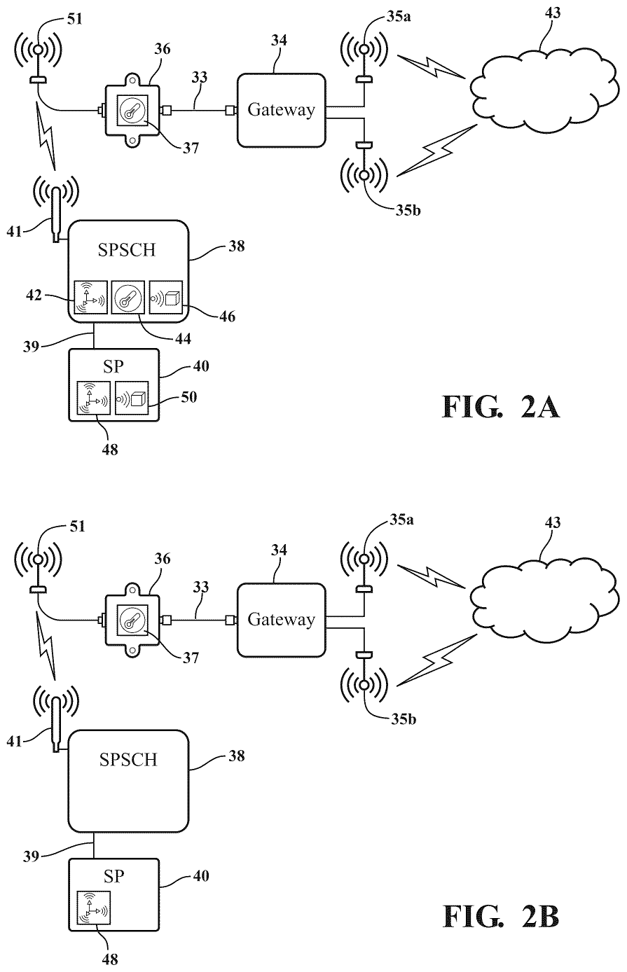

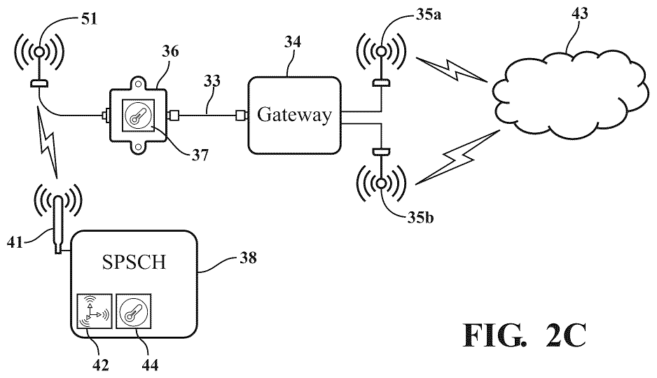

Still referring to FIG. 1 and now referring to FIGS. 2A-2C, in this embodiment, the example elevator assembly 10 may further include a gateway device 34 communicatively coupled to a radio frequency module 36, and a signal processing and state computation hub device 38. In some embodiments, the example elevator assembly 10 may further include an optional sensor package assembly 40 that is communicatively coupled to the signal processing and state computation hub device 38 via a controller area network communication (CAN) protocol 39, as discussed in greater detail herein.

In some embodiments, the radio frequency module 36 may be communicatively coupled to a gateway interface 51, which in turn is communicatively coupled to a transmitter 41 of the signal processing and state computation hub device 38. In some embodiments, the gateway interface 51 may be a wireless interface to provide wireless communication capabilities. In other embodiments, the gateway interface 51 may be a wired communication compatible. In some embodiments, the transmitter 41 may be wireless communication compatible. In other embodiments, the transmitter 41 may be wired communication compatible such as a wired communication protocol utilizing Ethernet. Further, in some embodiments, the communication between the gateway interface 51 and the transmitter 41 may be at a sub gigahertz wireless communication protocol frequency.

The radio frequency module 36 may be communicatively coupled to the gateway device 34 via a universal serial bus (USB) cable interface 33. As such, the radio frequency module 36 and the gateway device 34 may bidirectional transmit data between each other. For instance, the radio frequency module 36 may transmit data received from the signal processing and state computation hub device 38 and the static barometer sensor 37 to the gateway device 34 and the gateway device 34 may provide software updates to the radio frequency module 36 and to the over the USB interface and to the signal processing and state computation hub device 38 and sensor package assembly 40 via the gateway interface 51 and the transmitter 41 when updates are available.

The radio frequency module 36, the signal processing and state computation hub device 38, and the sensor package assembly 40, if included, may each be positioned in the hoistway 16 while the gateway device 34 may be positioned in the machine room 19. In some embodiments, the radio frequency module 36 may be mounted anywhere suitable in the hoistway 16 and may further include a static barometer sensor 37 configured to detect or sense a current pressure of the hoistway 16. As such, the static barometer sensor 37 may be stationary and configured to provide a stationary, or constant pressure of that position within the hoistway 16. The signal processing and state computation hub device 38 and the sensor package assembly 40, if included, may each be positioned on the elevator cab 12, for example, on the cabin roof 15, within or on the door panels 14, and/or the like.

The radio frequency module 36 may determine which frequency channels are already in use by other devices and selects an available channel for the radio frequency module 36 to use for this particular elevator assembly 10. The radio frequency module 36 may be configured to select the desired signal processing and state computation hub device 38 for pairing, and the radio frequency module 36 is configured to inform of instruct the signal processing and state computation hub device 38 which frequency channel normal communications will be used. After the pairing process is complete, both the radio frequency module 36 and the signal processing and state computation adjust their operating frequency to the selected frequency channel and begin normal communications between the devices.

As such, the radio frequency module 36 may be dynamically configured for the region/country of the example elevator assembly 10 transmits a plurality of beacon messages on an assigned frequency within that country frequency range while the signal processing and state computation hub device 38 alternately listens on two different frequencies to detect the beacon transmission, which, once detected, determines the operating frequency range for the example elevator assembly 10.

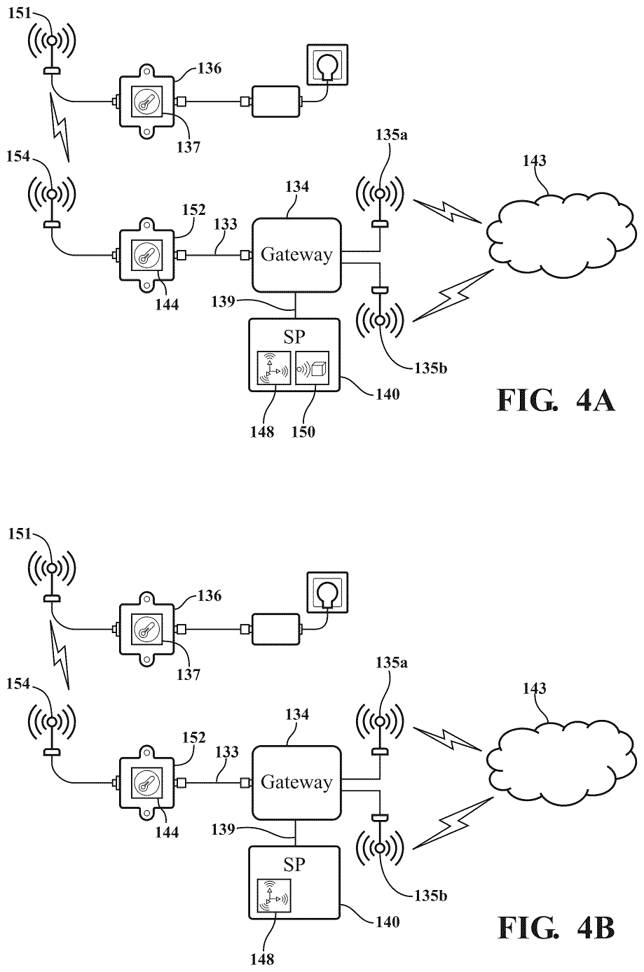

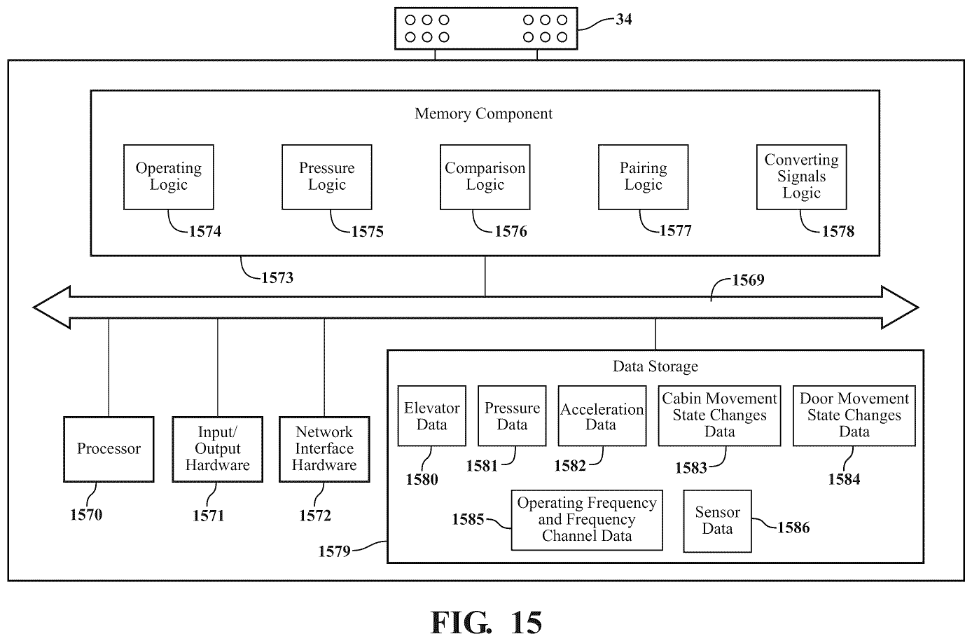

Still referring to FIGS. 2A-2C and now referring to FIG. 15, the gateway device 34 may be configured to process and compute data received from various sources, such as directly from the sensor package assembly 40 (as best illustrated in FIGS. 4A-4B), from the static barometer sensor 37 and the dynamic barometer sensor 44, from the signal processing and state computation hub device 38, and the like. The gateway device 34 may be configured to transform the raw accelerometer sensor data into door movement state changes (e.g., doors stopped, doors moving, door position, doors fully open, doors fully closed, and/or the like) as best illustrated in the example aspects depicted in FIGS. 4A-4B, 6, 8 and 10. The various sensors (e.g., the sensor package assembly 40, the dynamic barometer sensor 44, the static barometer sensor 37, and the like) may transmit raw data to the gateway device 34.

The gateway device 34 may include a non-transitory, computer readable medium configured for receiving raw data from the various sensors, analyzing such data, performing various operations and transmitting different or generated data indicative of elevator cabin movement state changes and/or door state changes, embodied as hardware, software, and/or firmware within the gateway device 34, according to embodiments shown and described herein. The gateway device 34 may be configured to transmit the generated data to a cloud-based central data processing service device 43 via mobile wireless interfaces 35a, 35b. The cloud-based central data processing service device 43 may be external to the gateway device 34 and remote to the gateway device 34.

While in some embodiments, the gateway device 34 may be configured as a general purpose computer with the requisite hardware, software, and/or firmware, in other embodiments, the gateway device 34 may be configured as a special purpose computer designed specifically for performing the functionality described herein. For example, the gateway device 34 may be a specialized device that particularly receives raw signals from various sensors (e.g., the sensor package assembly 40, the accelerometer sensor 42, the static barometer sensor 37, the dynamic barometer sensor 44, the time of flight sensor 46, and/or the like), perform analysis and transform the raw data into a different data, which is then transmitted to an external device, such as the a cloud-based central data processing service device 43. In a further example, the gateway device 34 may be a specialized device that further generates transformed data for transmission to the cloud based platform for the proposes of improving the accuracy of an external component for remotely monitoring positions of the door panels 14 and/or elevator cab 12 movements in the hoistway 16.

As also illustrated in FIG. 15, the gateway device 34 may include a processor 1570, input/output hardware 1571, network interface hardware 1572, a data storage component 1579, which stores a database of elevator data 1580, pressure data 1581, acceleration data 1582, cabin movement state changes data 1583, door movement state changes data 1584, operating frequency and frequency channel data 1585, and sensor data 1586, and a memory component 1573. The memory component 1573 may be non-transitory computer readable memory. The memory component 1573 may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. Additionally, the memory component 1573 may be configured to store operating logic 1574, pressure logic 1575, comparison logic 1576, pairing logic 1577, and converting signals logic 1578 (each of which may be embodied as a computer program, firmware, or hardware, as an example). A local interface 1569 is also included in FIG. 15 and may be implemented as a bus or other interface to facilitate communication among the components of the gateway device 34.

The processor 1570 may include any processing component(s) configured to receive and execute instructions (such as from the data storage component 1579 and/or memory component 1573). The input/output hardware 1571 may include a monitor, keyboard, mouse, printer, camera, microphone, speaker, and/or other device for receiving, sending, and/or presenting data. The network interface hardware 1572 may include any wired or wireless networking hardware, such as a modem, LAN port, Ethernet, wireless fidelity (Wi-Fi) card, WiMax card, mobile communications hardware, and/or other hardware for communicating with other networks and/or devices.

It should be understood that the data storage component 1579 may reside local to and/or remote from the gateway device 34 and may be configured to store one or more pieces of data for access by the gateway device 34 and/or other components, to gather raw data, transform data, convert data, and the like. As illustrated in FIG. 15, the data storage component 1579 stores the elevator data 1580 such as data related to the type of elevator, number of floors or landings, baseline readings or determinations of pressure, door movement speeds, cabin movement speeds and the like, that may be compared to current operating parameters to detect degrading of operations.

The pressure data 1581 includes a plurality of data related to sensed pressures by the dynamic barometer sensor 44, which is dynamic or variable based on the vertical location of the elevator cab 12 within the hoistway 16 and the static barometer sensor 37, which is mounted within the hoistway at a stationary position. The acceleration data 1582 may include data received from either or both the accelerometer sensor 48 of the sensor package assembly 40 and/or other accelerations data such as either raw or transformed data acquired from the accelerometer sensor 42 of the signal processing and state computation hub device 38. As such, the acceleration data 1582 may include data related to acceleration of the elevator cab 12 and/or data related to accelerations of the door panels 14 indicative of different movements. The cabin movement state changes data 1583 may include raw data or transformed raw data that has been analyzed, compared, or otherwise subjected to algorithms or other logic to determine elevator cab 12 movement data related to the current or past movements of the elevator cab 12, as discussed in greater detail herein. The cabin movement state changes data 1583 may be raw data or may be the transformed or converted data that is transmitted to the gateway device 34, or may be data that is transformed, converted, and/or generated by the gateway device 34 itself, as discussed in greater detail herein. The cabin movement state changes data 1583 may further include data generated by the gateway device 34 that assemblies and stores various cabin movement state changes as cabin movement events. As such, the cabin movement state changes data 1583 may include filtered data from raw signals to improve accuracy of the data transmitted to the cloud-based central data processing service device 43.

The door movement state changes data 1584 may include raw data or transformed raw data that has been analyzed, compared, or otherwise subjected to algorithms or other logic to determine door movement data related to the current or past movements of the door panels 14, as discussed in greater detail herein. The door movement state changes data 1584 may be the transformed or converted data that is transmitted to the gateway device 34, or may be data that is transformed, converted, and/or generated by the gateway device 34 itself, as discussed in greater detail herein. The door movement state changes data 1584 may further include data generated by the gateway device 34 that assemblies and stores various door movement state changes as door movement events. As such, the door movement state changes data 1584 may include filtered data from raw signals to improve accuracy of the data transmitted to the cloud-based central data processing service device 43.

The operating frequency and frequency channel data 1585 includes the data related to the determined wireless frequency band to use based on the country location of the equipment, the assigned frequency of the beacon messages, the two at least two different frequencies that the gateway device 34 configured to detect the beacon messages transmitted by the radio frequency module 36, and the determined operating frequency range for communication between the various components of the example elevator assembly 10 (FIG. 1) such as the radio frequency module 36 and/or the gateway device 34. The sensor data 1586 may include data as to the type of sensors used in the current example elevator assembly 10 (FIG. 1), the locations and position of the various sensors, what each of the sensors are configured to detect or sense, and the like.

Included in the memory component 1573 are the operating logic 1574, pressure logic 1575, comparison logic 1576, pairing logic 1577, and converting signals logic 1578. The operating logic 1574 may include an operating system and/or other software for managing components of the gateway device 34. The pressure logic 1575 may contain programming instructions to instruct the static barometer sensor 37 and/or the dynamic barometer sensor 44 to take or transmit periodic pressure readings. Further, in some aspects, the pressure logic 1575 may calculate or determine a difference between a new pressure reading and a previous measured pressure reading (ΔPressure). The pressure logic 1575 may prepare for the raw pressure data from the static barometer sensor 37 and/or the dynamic barometer sensor 44 to be transmitted to the gateway device 34, for further analysis, as discussed in greater detail herein.

The comparison logic 1576 may contain programming instructions to evaluate or analyze data from various sensors to more accurately determine the door movement states and the elevator cab movements. For example, the comparison logic 1576 may be configured to facilitate data comparisons between the raw data sensed by the various sensors of the sensor package assembly 40 and the raw data sensed by the static barometer sensor 37 to evaluate and determine elevator cabin movement states and/or door movement states. Such comparisons improve accuracy of the data transmitted to other components of the network such as to the cloud-based central data processing service device 43.

The pairing logic 1577 may contain programming instructions to automatically pair the gateway device 34 to the signal processing and state computation hub device 38 and/or to the to the radio frequency module 36. The pairing logic 1577 may be configured to search for and receive various beacon messages on an assigned frequency transmitted by the radio frequency module 36 by monitoring at least two different frequencies to detect the beacon transmission, which, once detected, the pairing logic 1577 may then determine the operating frequency range for the gateway device 34. After the operating frequency range is determined, the pairing logic 1577 may automatically determine, either alone or with the signal processing and state computation hub device 38 and/or to the to the radio frequency module 36, the frequency channel that will be used as the operating frequency by the gateway device 34 and segments each of the globally administered frequency bands into a number of channels, the total of which is determined by a channel separation variable, with each channel occupied by the gateway device 34, the radio frequency module 36, and the signal processing and state computation hub device 38 combination.

The converting signals logic 1578 may contain programming instructions to convert or otherwise transform the raw signals received from the various sensors (e.g., the sensor package assembly 40, the static barometer sensor 37, the dynamic barometer sensor 44, and/or the like) into new data that is indicative of door movement state changes, elevator cabin movement state changes, and the like. As such, the converting signals logic 1578 may use machine learning, various algorithms, and the like, to transform or otherwise analyze, filter, calculate, determine and generate new data. Further, the converting signals logic 1578 may contain programming instructions to receive data that is indicative of door movement state changes, elevator cabin movement state changes, and the like, and assembly this data and converted the assemblies data into specific events, such as cabin movement events and door movement events, for transmission to the cloud-based central data processing service device 43 indicative of the specific events for the purposes of improving accuracy and permitting for the remote monitoring of the example elevator assembly 10 for operating conditions, early detection of predictive maintenance or failure, undesirable conditions, and the like. As such, the gateway device 34 transforms the door movement state changes into door movement events and the cabin movement state changes into cabin movement events, which are in turn transmitted to the cloud-based central data processing service device 43 using much less data then sending raw data or the unassembled data.

It should be understood that the components depicted in FIG. 15 are merely illustrative and are not intended to limit the scope of this disclosure. More specifically, while the components in FIG. 15 are illustrated as residing within the gateway device 34, this is a non-limiting example. In some embodiments, one or more of the components may reside external to the gateway device 34. Similarly, while FIG. 15 is directed to the gateway device 34, other components such as the signal processing and state computation hub device 38 may include similar hardware, software, and/or firmware, as discussed in greater detail herein.

Now referring back to FIG. 2A, in this aspect, the signal processing and state computation hub device 38 may include an accelerometer sensor 42, a dynamic barometer sensor 44, and a time of flight sensor 46. The accelerometer sensor 42 may be configured to detect or sense accelerations of the elevator cab 12 within the hoistway 16, and/or door movements of the door panels 14, as discussed in greater detail herein. For example, the accelerometer sensor 42 may be positioned or mounted to a door header 27 of the door panels 14 and configured to measure movement of the elevator cab 12. In other aspects or in combination with detecting movement of the elevator cab 12, the accelerometer sensor 42 may be configured to measure accelerations of the door panels 14, from which a velocity and/or jerk may be derived, thereby determining the dynamic position of the door panels 14.

The dynamic barometer sensor 44 may be configured to detect or sense a current, real-time pressure at the elevator cab 12 within the hoistway 16. As such, the dynamic barometer sensor 44 senses pressures with movement of the elevator cab 12. The time of flight sensor 46 may be configured to detect or sense a distance of movement door of the door panels 14. For example, the time of flight sensor 46 may be positioned on one end of a door hanger track and the time of flight sensor 46 may be configured to detect a target 29 on the door panels 14 or the door operator to detect distance changes between the target 29 and the time of flight sensor 46 indicative of door panel 14 movements as a raw door distance data.

The accelerometer sensor 42 may be configured to detect or sense acceleration of the elevator cab 12 within the hoistway 16, and/or door movements of the door panels 14, as discussed in greater detail herein. For example, the accelerometer sensor 42 may be positioned or mounted to the door header 27 of the door panels 14 of the elevator cab 12 and configured to measure movements of the elevator cab 12 and/or door movements of the door panels 14.

The dynamic barometer sensor 44 may be configured to detect or sense a current, real-time pressure at the elevator cab 12 within the hoistway 16. As such, the dynamic barometer sensor 44 senses pressures with movement of the elevator cab 12. The time of flight sensor 46 may be configured to detect or sense a distance of movement door of the door panels 14. For example, the time of flight sensor 46 may be positioned on one end of a door hanger track and the time of flight sensor 46 may be configured to detect the target 29 on the door panel 14 or the door operator to detect distance changes between the target 29 and the time of flight sensor 46 indicative of door panel 14 movements.

Further, in this aspect, the sensor package assembly 40 may further include an accelerometer sensor 48 and a time of flight sensor 50. The accelerometer sensor 48 and a time of flight sensor 50 are independent and distinct from the time of flight sensor 46 and the accelerometer sensor 42 of the signal processing and state computation hub device 38. In some embodiments, the sensor package assembly 40 including the accelerometer sensor 48 and the time of flight sensor 50 is mounted on the door header 27 or door panels 14 of the elevator cab 12 and is communicatively coupled to the signal processing and state computation hub device 38 via the CAN protocol 39. As such, the sensor package assembly 40 may be configured to detect or transmit data related to the distance of movement door of the door panels 14 via the time of flight sensor 50 and/or movement of the door panels 14 in the form of accelerations via the accelerometer sensor 48. That is, the accelerometer sensor 48 may be configured to measure accelerations of the door panels 14, from which a velocity and/or jerk may be derived, thereby determining the dynamic position of the door panels 14.

The various sensed, collected, or otherwise obtained data by the sensor package assembly 40 is transmitted to the signal processing and state computation hub device 38 via the CAN protocol 39 as raw data for processing by the signal processing and state computation hub device 38, as discussed in greater detail herein.

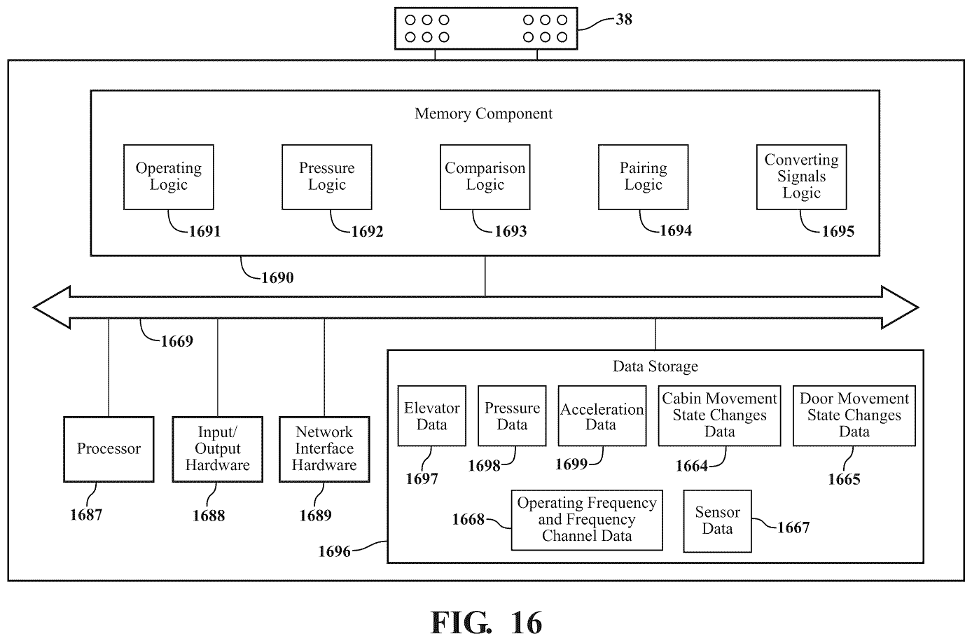

Still referring to FIG. 2A and now to FIG. 16, the signal processing and state computation hub device 38 may be configured to process and compute data received from the time of flight sensor 46, the accelerometer sensor 42, and the sensor package assembly 40. The signal processing and state computation hub device 38 may be configured to transform the raw accelerometer sensor data into door movement state changes (e.g., doors stopped, doors moving, door position, doors fully open, doors fully closed, and/or the like) and into events. The signal processing and state computation hub device 38 may transmit door movement state changes and/or other generated data to the gateway device 34 via the transmitter 41.

As such, the signal processing and state computation hub device 38 may include a non-transitory, computer readable medium configured for receiving raw data from various sensors, analyzing such data, performing various operations and transmitting different or new data to the gateway device 34, embodied as hardware, software, and/or firmware, according to embodiments shown and described herein.

While in some embodiments, the signal processing and state computation hub device 38 may be configured as a general purpose computer with the requisite hardware, software, and/or firmware, in other embodiments, the signal processing and state computation hub device 38 may be configured as a special purpose computer designed specifically for performing the functionality described herein. For example, the signal processing and state computation hub device 38 may be a specialized device that particularly receives raw signals from various sensors (e.g., the sensor package assembly 40, the accelerometer sensor 42, the dynamic barometer sensor 44, the time of flight sensor 46, and the like), perform analysis and transform the raw data into a different data, which is then transmitted to an external device, such as the gateway device 34 for further analysis and processing, as discussed in greater detail herein. In a further example, the signal processing and state computation hub device 38 may be a specialized device that further generates transformed data for transmission to a cloud based platform via the gateway device 34 and then provides the generated transformed data to the gateway device 34 for the proposes of improving the accuracy of an external component for remotely monitoring positions of the door panels 14 and/or elevator cab 12 movements in the hoistway 16.

As also illustrated in FIG. 16, the signal processing and state computation hub device 38 may include a processor 1687, input/output hardware 1688, network interface hardware 1689, a data storage component 1696, which stores a database of elevator data 1697, pressure data 1698, acceleration data 1699, cabin movement state changes data 1664, door movement state changes data 1665, operating frequency and frequency channel data 1668, and sensor data 1667, and a memory component 1690. The memory component 1690 may be non-transitory computer readable memory. The memory component 1690 may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. Additionally, the memory component 1690 may be configured to store operating logic 1691, pressure logic 1692, comparison logic 1693, pairing logic 1694, and converting signals logic 1695 (each of which may be embodied as a computer program, firmware, or hardware, as an example). A local interface 1669 is also included in FIG. 16 and may be implemented as a bus or other interface to facilitate communication among the components of the signal processing and state computation hub device 38.

The processor 1687 may include any processing component(s) configured to receive and execute instructions (such as from the data storage component 1696 and/or memory component 1690). The input/output hardware 1688 may include a monitor, keyboard, mouse, printer, camera, microphone, speaker, and/or other device for receiving, sending, and/or presenting data. The network interface hardware 1689 may include any wired or wireless networking hardware, such as a modem, LAN port, Ethernet, wireless fidelity (Wi-Fi) card, WiMax card, mobile communications hardware, and/or other hardware for communicating with other networks and/or devices.

It should be understood that the data storage component 1696 may reside local to and/or remote from the signal processing and state computation hub device 38 and may be configured to store one or more pieces of data for access by the signal processing and state computation hub device 38 and/or other components, to gather raw data, transformed data, converted data, generate new data, and the like. As illustrated in FIG. 16, the data storage component 1696 stores the elevator data 1697, which may include data relating to the type of elevator, number of floors or landings, baseline readings or determinations of pressure, door movement speeds, cabin movement speeds and the like, that may be compared to current operating parameters to detect degrading of operations.

The pressure data 1698 includes a plurality of data related to sensed pressures by the dynamic barometer sensor 44, which is dynamic or variable based on the vertical location of the elevator cab 12 within the hoistway 16. The acceleration data 1699 may include data received from either or both the accelerometer sensor 48 of the sensor package assembly 40 and the accelerometer sensor 42 of the signal processing and state computation hub device 38. As such, the acceleration data 1699 may include data related to acceleration of the elevator cab 12 and/or data related to accelerations of the door panels 14. The cabin movement state changes data 1664 may include transformed raw data that has been analyzed, compared, or otherwise subjected to algorithms or other logic to determine elevator cab 12 movement data related to the current or past movements of the elevator cab 12, as discussed in greater detail herein. The cabin movement state changes data 1664 may be the transformed or converted data that is transmitted to the gateway device 34 as state changes or events, as discussed in greater detail herein. As such, the cabin movement state changes data 1664 may include filtered data from raw signals to improve accuracy of the data transmitted ultimate to the cloud-based central data processing service device 43.

The door movement state changes data 1665 may include transformed raw data that has been analyzed, compared, or otherwise subjected to algorithms or other logic to determine door movement data related to the current or past movements of the door panels 14, as discussed in greater detail herein. The door movement state changes data 1665 may be the transformed or converted data that is transmitted to the gateway device 34, as discussed in greater detail herein. As such, the door movement state changes data 1665 may include filtered data from raw signals to improve accuracy of the data transmitted ultimate to the cloud-based central data processing service device 43.

The operating frequency and frequency channel data 1668 includes the data related to the determined wireless frequency band to use based on the country location of the equipment, the assigned frequency of the beacon messages, the two at least two different frequency that the signal processing and state computation hub device 38 is configured to detect the beacon messages transmitted by the radio frequency module 36, and the determined operating frequency range for communication between the various components of the example elevator assembly 10 (FIG. 1). The sensor data 1667 may include data as to the type of sensors used in the current example elevator assembly 10 (FIG. 1), the locations and position of the various sensors, what each of the sensors are conducted to detect or sense, and the like.

Included in the memory component 1690 are the operating logic 1691, pressure logic 1692, comparison logic 1693, pairing logic 1694, and converting signals logic 1695. The operating logic 1691 may include an operating system and/or other software for managing components of the signal processing and state computation hub device 38. The pressure logic 1692 may contain programming instructions to instruct the dynamic barometer sensor 44 to take or transmit periodic pressure readings. Further, in some aspects, the pressure logic 1692 may calculate or determine a difference between a new pressure reading and a previous measured pressure reading (ΔPressure). The pressure logic 1692 may prepare for the raw or transformed pressure data to be transmitted to the gateway device 34, for further analysis, as discussed in greater detail herein.

The comparison logic 1693 may contain programming instructions to evaluate or analyze data from various sensors to more accurately determine the door movement states and the elevator cab movements. For example, the comparison logic 1693 may be configured to facilitate data comparisons between the raw data sensed by the accelerometer sensor 48 of the sensor package assembly 40 and the raw data sensed by the accelerometer sensor 42 of the signal processing and state computation hub device 38 for either or both elevator cabin movement states and door movement states. Such comparisons improves accuracy of the data transmitted to other components of the signal processing and state computation hub device 38 for further analysis.

The pairing logic 1694 may contain programming instructions to automatically pair the signal processing and state computation hub device 38 to the to the radio frequency module 36. The pairing logic 1694 may be configured to search for and receive various beacon messages on an assigned frequency transmitted by the radio frequency module 36 by monitoring at least two different frequencies to detect the beacon transmission, which, once detected, the pairing logic 1694 then determines the operating frequency range for the signal processing and state computation hub device 38. After the operating frequency range is determined, the pairing logic 1694 may automatically determine, either alone or with the gateway device 34 and/or the radio frequency module 36, the frequency channel that will be used as the operating frequency by the signal processing and state computation hub device 38 and segments each of the globally administered frequency bands into a number of channels, the total of which is determined by a channel separation variable, with each channel occupied by the gateway device 34, the radio frequency module 36, and the signal processing and state computation hub device 38 combination.

The converting signals logic 1695 may contain programming instructions to convert or otherwise transform the raw signals received from the various sensors (e.g., the accelerometer sensor 48, the accelerometer sensor 42, the time of flight sensor 46, and the time of flight sensor 50) into new data that is indicative of specific events, such as door movement state changes, elevator cabin movement state changes, and the like. As such, the converting signals logic 1695 may use machine learning, various algorithms, and the like, to transform or otherwise analyze, filter, calculate, determine and generate new data for transmission to the gateway device 34 indicative of the specific events for the purposes of improving accuracy and permitting for the remote monitoring of the example elevator assembly 10 for operating conditions, early detection of predictive maintenance or failure, undesirable conditions, and the like.

It should be understood that the components depicted in FIG. 16 are merely illustrative and are not intended to limit the scope of this disclosure. More specifically, while the components in FIG. 16 are illustrated as residing within the signal processing and state computation hub device 38, this is a non-limiting example. In some embodiments, one or more of the components may reside external to the signal processing and state computation hub device 38. Similarly, while FIG. 16 is directed to the signal processing and state computation hub device 38, other components such as the gateway device 34 may include similar hardware, software, and/or firmware.

It should also be understood that in the embodiments or aspects described herein that includes both the signal processing and state computation hub device 38 and the gateway device 34, the data analyzed, filtered, calculated, determined and/or generated as new data for transmission from the signal processing and state computation hub device 38 to the gateway device 34, may be subject to any analysis by the gateway device, and may be assembled into a different format, such as data events and the gateway device 34 may then transmit the newly generated data to the cloud-based central data processing service device 43. Other raw data sent by the signal processing and state computation hub device 38 to the gateway device 34 (e.g., the data sensed by the dynamic barometer sensor 44) may be analyzed, filtered, calculated, determined and/or generated as new data by the gateway device 34 for transmission to the cloud-based central data processing service device 43. Further, it should also be understood that in the embodiments or aspects described herein that only includes the gateway device 34, the gateway device 34 performs the functionality described herein to analyze, filter, calculate, determine, and/or generate new data to the cloud-based central data processing service device 43.

Once the signal processing and state computation hub device 38 generates the new data as door movement state changes (e.g., doors stopped, doors moving, door position, doors fully open, doors fully closed), and/or cabin movement state changes, the signal processing and state computation hub device 38 then transmits the door movement state changes data and/or the cabin movement state changes to the gateway device 34 via the transmitter 41 to the gateway interface 51. The gateway device 34 receives the door movement state changes and/or the cabin movement state changes and assembles and transmits door movement events and/or the cabin movement events to the cloud-based central data processing service device 43 via the mobile wireless interface 35a, 35b.

Now referring back to FIG. 2B, in this aspect, the sensor package assembly 40 may include the accelerometer sensor 48 and the sensor package assembly 40 may be communicatively coupled to the signal processing and state computation hub device 38 via the CAN protocol 39. In this aspect, the sensor package assembly 40 may be mounted to the door panels 14 and the signal processing and state computation hub device 38 may be mounted to the cabin roof 15 of the elevator cab 12. The accelerometer sensor 48 of the sensor package assembly 40 may be configured to detect or sense acceleration with respect to door movements of the door panels 14 (e.g., a velocity and/or jerk may be derived, thereby determining the dynamic position of the door panels 14). The various sensed, collected, or otherwise obtained data by the sensor package assembly 40 is transmitted to the signal processing and state computation hub device 38 via the CAN protocol 39 as raw data for processing by the signal processing and state computation hub device 38, as discussed in greater detail herein. Once the signal processing and state computation hub device 38 generates the new data as door movement state changes (e.g., doors stopped, doors moving, door position, doors fully open, doors fully closed), the signal processing and state computation hub device 38 then transmits the door movement state changes data to the gateway device 34 via the transmitter 41 to the gateway interface 51. The gateway device 34 receives the door movement state changes and assembles and transmits door movement events to the cloud-based central data processing service device 43 via the mobile wireless interface 35a, 35b.

Now referring back to FIG. 2C, in this aspect, the signal processing and state computation hub device 38 may include the accelerometer sensor 42 and the dynamic barometer sensor 44. The signal processing and state computation hub device 38 may be mounted to the door header 27 to the cabin roof 15 of the elevator cab 12. The accelerometer sensor 42 may be configured to sense or detect acceleration of the elevator cab 12, from which velocity and jerk can also be derived, thereby sending data related to the dynamic position of the elevator cab 12. The dynamic barometer sensor 44 measures air pressure at the elevator cab 12, from which vertical displacement be derived when the elevator cab 12 moves, thereby determining the dynamic vertical position of the elevator cab 12.

The signal processing and state computation hub device 38 may transform the raw pressures data sensed by the dynamic barometer sensor 44 and the accelerations data sensed by the accelerometer sensor 42 into cabin movement state changes (cabin stopped, cabin moving, cabin position). The signal processing and state computation hub device 38 may then transmit cabin movement state changes to the gateway device 34 via the transmitter 41, which is received by the gateway interface 51. The static barometer sensor 37 detects or senses air pressure at a fixed location within the hoistway 16 and provides a static air pressure reference to compensate for air pressure changes to the gateway device 34. The gateway device 34 transforms the cabin movement state changes into cabin movement events which are in turn transmitted to a cloud-based central data processing service device 43.

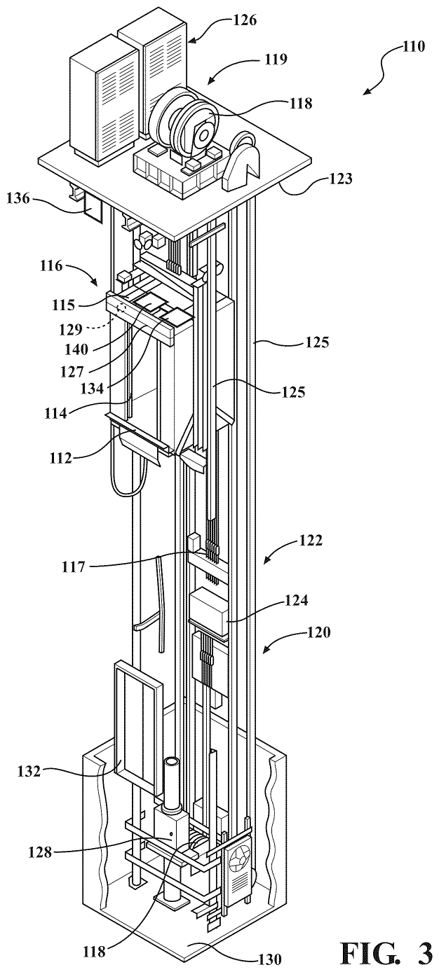

Now referring to FIGS. 3 and 4A-4B, a second aspect of an example elevator assembly 110 is schematically depicted. It is understood that the example elevator assembly 110 is similar to the example elevator assembly 10 with the exceptions of the features described herein. As such, like features will use the same reference numerals with a prefix “1” for the reference numbers. As such, for brevity reasons, these features will not be described again.

Now referring to FIGS. 3 and 4A, in this aspect, the gateway device 34 and the signal processing and state computation hub device 38 are combined into a gateway device 134 that may be mounted on the cabin roof 115 and communicatively coupled to gateway interface 151 for the radio frequency module 136 via the interface 154. A dynamic radio frequency module 152 is communicatively coupled to the gateway device 134 via the USB cable interface 133. The sensor package 140 may be communicatively coupled to the gateway device 134 via the CAN protocol 139. The dynamic radio frequency module 152 and the gateway device 134 may be mounted to the cabin roof 115. The sensor package 140 may be mounted to the door header 127, the door panels 114, or to the cabin roof 115. The dynamic radio frequency module 152 includes the dynamic barometer sensor 144. The sensor package 140 includes the accelerometer sensor 148 and the time of flight sensor 150.

In some embodiments, the sensor package 140 may be mounted on the door header 127, and/or may be positioned in the center of the door panels 114 and uses the time of flight sensor 150 to sense or detect door movements of the door panels 114 via changes in the distance between the target 129 and the time of flight sensor 150, and the accelerometer sensor 148 to measure cabin movements. The data sensed or detected by the dynamic barometer sensor 144 and the data sensed by the accelerometer sensor 148 are indicative of cabin movements while the data detected or sensed by the time of flight sensor 150 are indicative of door movements of the door panels 114.

In other embodiments, the sensor package 140 may be mounted on the door header 127 of the door panels 114 and uses the data sensed or detected by the accelerometer sensor 148 for both door movements and cabin movements. The data generated or detected or sensed by the dynamic barometer sensor 144 of the dynamic radio frequency module 152 and the data from the accelerometer sensor 148 is utilized to detect cabin movements of the elevator cab 112 and the accelerometer data to detect door movements of the door panel 114.

Now referring to FIGS. 3 and 4B, in this aspect, the gateway device 134 is communicatively coupled to gateway interface 151 for the radio frequency module 136 via the interface 154. The dynamic radio frequency module 152 is communicatively coupled to the gateway device 134 via the USB cable interface 133. The sensor package 140 may be communicatively coupled to the gateway device 134 via the CAN protocol 139. The dynamic radio frequency module 152 and the gateway device 134 may be mounted to the cabin roof 115. The sensor package 140 may be mounted to the door header 127, the door panels 114, or to the cabin roof 115. The dynamic radio frequency module 152 includes the dynamic barometer sensor 144. The sensor package 140 includes the accelerometer sensor 148.

In some embodiments, the sensor package 140 may be mounted to the door header 127 of the door panels 114 or to the cabin roof 115. The data sensed or detected by the dynamic barometer sensor 144 and the data sensed by the accelerometer sensor 148 are indicative of cabin movements. The gateway device 134 determines cabin state movement changes by analyzing raw data from the dynamic barometer sensor 144 and the accelerometer sensor 148 and generating the cabin movement state changes data, as discussed in greater detail above. The gateway device 34 assemblies and stores various cabin movement state changes as cabin movement events and transmits the events to the cloud-based central data processing service devices 143 via the cellular wires interface 135a, 135b.

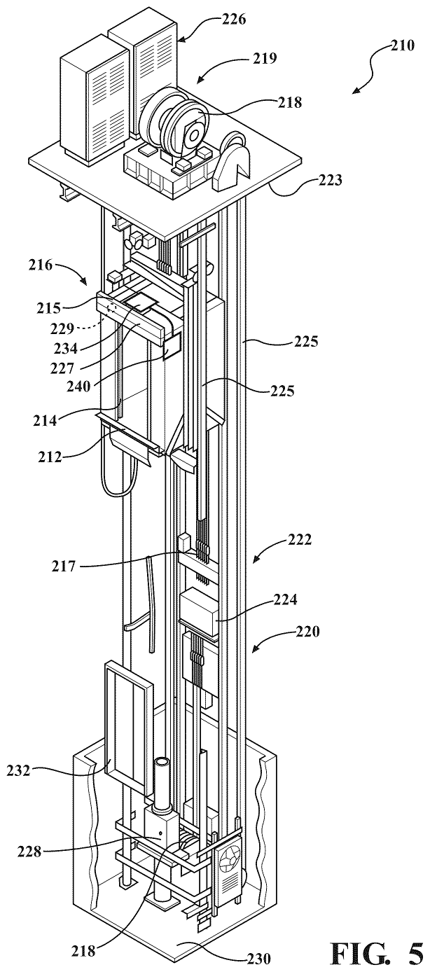

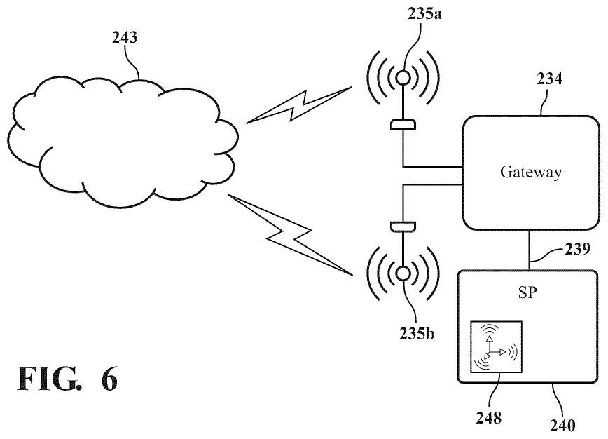

Now referring to FIGS. 5-6, a third aspect of an example elevator assembly 210 is schematically depicted. It is understood that the example elevator assembly 210 is similar to the example elevator assembly 110 with the exceptions of the features described herein. As such, like features will use the same reference numerals with a prefix “2” for the reference numbers. As such, for brevity reasons, these features will not be described again.

In this aspect, the gateway device 34 and the signal processing and state computation hub device 38 are combined into a gateway device 234 that may be mounted on the cabin roof 215 such that the gateway device includes the data storage component 1696 (FIG. 16) and/or the memory component 1690 (FIG. 16) of the signal processing and state computation hub device 38 herein referred to as the signal processing and state computation hub device library. A sensor package 240 may be communicatively coupled to the gateway device 234 via the CAN protocol 239. The sensor package 240 may be mounted to the door header 127 or to the door panels 214. The sensor package 140 includes the accelerometer sensor 148 configured to sense or detect door panel movements of the door panels 214. The data sensed or detected by the accelerometer sensor 148 are indicative of door movements of the door panels 114.

The gateway device 134 determines door movement state changes by analyzing raw data from the accelerometer sensor 148 and generating the door movement state changes data, as discussed in greater detail above. The gateway device 34 assemblies and stores various door movement state changes as door movement events and transmits the events to the cloud-based central data processing service devices 143 via the cellular wires interface 135a, 135b.

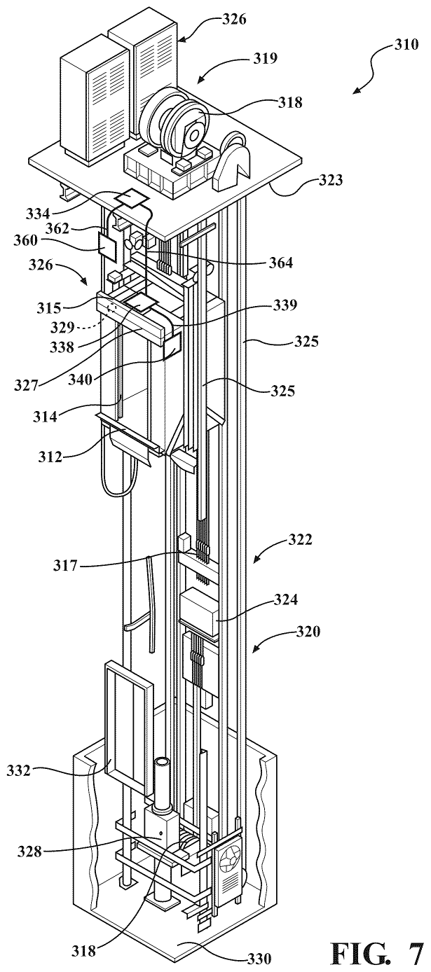

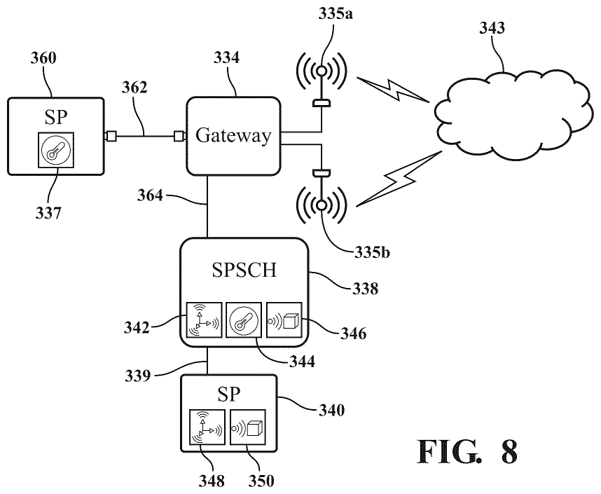

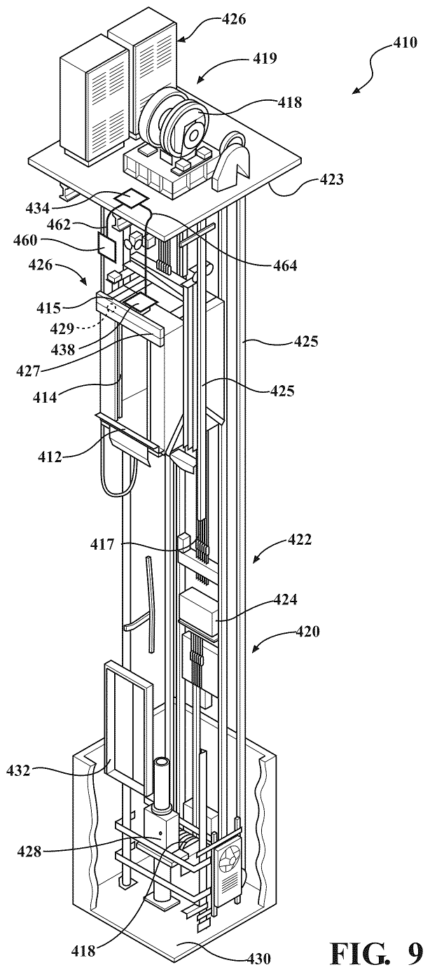

Now referring to FIGS. 7-8, a fourth aspect of an example elevator assembly 310 is schematically depicted. It is understood that the example elevator assembly 310 is similar to the example elevator assembly 10 with the exceptions of the features described herein. As such, like features will use the same reference numerals with a prefix “3” for the reference numbers. As such, for brevity reasons, these features will not be described again.

The example elevator assembly 310 may further include the gateway device 334 communicatively coupled to a sensor package assembly 360 via a communication cable interface 362, the signal processing and state computation hub device 338, and the sensor package assembly 340 that is communicatively coupled to the signal processing and state computation hub device 338 via the CAN protocol 339. The signal processing and state computation hub device 338 is communicatively coupled to the gateway device 334 via an Ethernet cable interface 364. The Ethernet cable interface 364 may be sized and shape to transmit data the length of the hoistway 316 such that the Ethernet cable interface 364 may travel with the signal processing and state computation hub device 338 mounted to the elevator cab 312 and still be fixedly coupled to the gateway device 334.

As such, it should be appreciated the various devices (e.g., the gateway device 334, the sensor package assembly 360, the signal processing and state computation hub device 338, and the sensor package assembly 340) are each communicatively coupled to one another via wired interfaces and would not necessarily need to be paired to one another as described in greater detail above.

The sensor package assembly 360 may be stationary or static and include the static barometer sensor 337, which may be positioned within a stationary position in the hoistway 316 and is configured to detect or sense a current pressure of the hoistway 316. The gateway device 334 may be positioned in the machine room 319 or in the hoistway 316, but is configured to remain stationary. The signal processing and state computation hub device 338 may be positioned on the elevator cab 312, for example, on the cabin roof 315, or on the door header 327 for the door panels 314. The sensor package assembly 340 may be positioned on the elevator cab 312, for example, on the door header for the door panels 314 or on the door panels 314 themselves.

In this aspect, the signal processing and state computation hub device 338 may include the accelerometer sensor 342, the dynamic barometer sensor 344, and the time of flight sensor 346. The accelerometer sensor 342 may be configured to detect or sense accelerations of the elevator cab 312 within the hoistway 16, and/or door movements of the door panels 314, as discussed in greater detail herein. For example, the accelerometer sensor 342 may be positioned or mounted to the door header 327 of the door panels 314 of the elevator cab 312 and configured to measure movements of the elevator cab 312. In other aspects or in combination with detecting movement of the elevator cab 312, the accelerometer sensor 342 may be configured to measure accelerations of the door panels 314, from which a velocity and/or jerk may be derived, thereby determining the dynamic position of the door panels 314.

The dynamic barometer sensor 344 may be configured to detect or sense a current, real-time pressure at the elevator cab 312 within the hoistway 316. As such, the dynamic barometer sensor 344 senses pressures with movement of the elevator cab 312. The time of flight sensor 346 may be configured to detect or sense a distance of movement door of the door panels 314. For example, the time of flight sensor 346 may be positioned on one end of a door hanger track and the time of flight sensor 346 may be configured to detect the target 329 on the door panel 314 or the door operator to detect distance changes between the target 329 and the time of flight sensor 346 indicative of door panel 314 movements.

Further, the sensor package assembly 340 may further include the accelerometer sensor 348 and the time of flight sensor 350. The accelerometer sensor 348 and the time of flight sensor 350 are independent and distinct from the time of flight sensor 346 and the accelerometer sensor 342 of the signal processing and state computation hub device 338. In some embodiments, the sensor package assembly 340 including the accelerometer sensor 348 and the time of flight sensor 350 is mounted on the door header 327 or door panels 314 of the elevator cab 312. As such, the sensor package assembly 340 may be configured to detect or transmit data related to the distance of movement door of the door panels 314 via the time of flight sensor 350 and/or movement of the door panels 314 in the form of accelerations via the accelerometer sensor 348. That is, the accelerometer sensor 348 may be configured to measure accelerations of the door panels 314, from which a velocity and/or jerk may be derived, thereby determining the dynamic position of the door panels 314.

In some embodiments, the signal processing and state computation hub device 338 may be mounted to one end of the door hanger track and uses the time of flight sensor 350 to detect the target 329 on the door panels 314 or the door operator for door movements and the dynamic barometer sensor 344 and the accelerometer sensor 342 to collectively detect vertical displacement and acceleration for cabin movement of the elevator cab 312.

In other embodiments, the signal processing and state computation hub device 338 may be mounted to the door header 327 of the door panels 314 or cabin roof 315 and connected via the CAN protocol 339 to the sensor package assembly 340 such that the time of flight sensor 350 detects the target 329 on the door panels 314 or the door operator for door movements and the dynamic barometer sensor 344 and the accelerometer sensor 342 of the in the signal processing and state computation hub device 338 collectively detect vertical displacement and acceleration of the elevator cab 312 indicative of cabin movement.

In another embodiment, the signal processing and state computation hub device 338 may be mounted to the door header 327 of the door panels 314 or cabin roof 315 in which the accelerometer sensor 348 of the sensor package assembly 340 detect door movements via accelerations, velocities, and/or jerking of the door panels 314. The dynamic barometer sensor 344 and the accelerometer sensor 342 in the signal processing and state computation hub device 338 may be used collectively to detect vertical displacement and acceleration of the elevator cab 312 indicative of cabin movement.

The various sensed, collected, or otherwise obtained data by the sensor package assembly 340 is transmitted to the signal processing and state computation hub device 38 via the CAN protocol 339 as raw data for processing by the signal processing and state computation hub device 338, as discussed in greater detail herein.

Once the signal processing and state computation hub device 338 generates the new data as door movement state changes (e.g., doors stopped, doors moving, door position, doors fully open, doors fully closed), and/or cabin movement state changes, the signal processing and state computation hub device 338 then transmits the door movement state changes data and/or the cabin movement state changes to the gateway device 334 via the Ethernet cable interface 364. The gateway device 334 receives the door movement state changes and/or the cabin movement state changes and assembles and transmits door movement events and/or the cabin movement events to the cloud-based central data processing service 343 via the mobile wireless interface 335a, 335b.

The static barometer sensor 337 detects or senses air pressure at a fixed location within the hoistway 316 and provides a static air pressure reference to compensate for air pressure changes to the gateway device 334. The gateway device 334 uses the data provided by the static barometer sensor 337 and the dynamic barometer sensor 344 to transform the data into the cabin movement state changes and into cabin movement events, which are in turn transmitted to the cloud-based central data processing service 343 via the mobile wireless interface 335a, 335b.

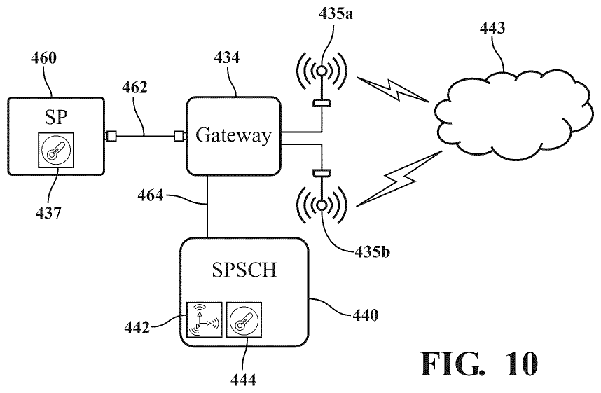

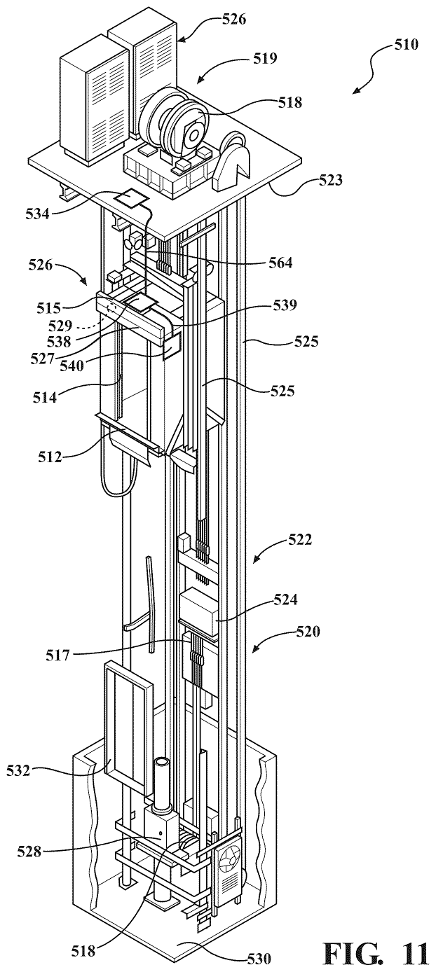

Now referring to FIGS. 9-10, a fifth aspect of an example elevator assembly 410 is s chematically depicted. It is understood that the example elevator assembly 410 is similar to the example elevator assembly 310 with the exceptions of the features described herein. As such, like features will use the same reference numerals with a prefix “4” for the reference numbers. As such, for brevity reasons, these features will not be described again.

The example elevator assembly 410 may further include the gateway device 434 communicatively coupled to the sensor package assembly 460 via a communication cable interface 462, and the signal processing and state computation hub device 438 communicatively coupled to the gateway device 434 via the Ethernet cable interface 464. As such, it should be appreciated the various devices (e.g., the gateway device 434, the sensor package assembly 460, and the signal processing and state computation hub device 438) are each communicatively coupled to one another via wired interfaces and may not necessarily need to be paired, as described in greater detail above.

The sensor package assembly 460 may include the static barometer sensor 437, which may be positioned within a stationary position in the hoistway 416 and is configured to detect or sense a current pressure of the hoistway 416. The gateway device 434 may be positioned in the machine room 419 or in the hoistway 416, but is configured to remain stationary. The signal processing and state computation hub device 438 may be positioned on the elevator cab 412, for example, on the cabin roof 415, or on the door header 427 for the door panels 414. In this aspect, the signal processing and state computation hub device 338 may include the accelerometer sensor 442 and the dynamic barometer sensor 444.

In some embodiments, the signal processing and state computation hub device 438 may be mounted to the door header 427 of the door panels 414 and uses the dynamic barometer sensor 444 and the accelerometer sensor 442 to detect movement of the elevator cab 412 indicative of cabin movements. In other embodiments, the signal processing and state computation hub device 438 may be mounted to the cabin roof 415 and uses dynamic barometer sensor 444 and the accelerometer sensor 442 to detect movement of the elevator cab 412 indicative of cabin movements.

As such, the accelerometer sensor 442 may be configured to detect or sense accelerations of the elevator cab 312 within the hoistway 416, and the dynamic barometer sensor 344 may be configured to detect or sense a current, real-time pressure at the elevator cab 412 within the hoistway 316. As such, the dynamic barometer sensor 444 senses pressures with movement of the elevator cab 412. As such, the signal processing and state computation hub device 438 may receive raw data from the dynamic barometer sensor 444 and the accelerometer sensor 442 to use the data to determine vertical displacement and acceleration for cabin movement of the elevator cab 412, as discussed in greater detail above.

Once the signal processing and state computation hub device 438 generates the new data as cabin movement state changes, the signal processing and state computation hub device 438 then transmits the cabin movement state changes to the gateway device 434 via the Ethernet cable interface 464. The gateway device 434 receives the cabin movement state changes and assembles and transmits the cabin movement events to the cloud-based central data processing service 443 via the mobile wireless interface 435a, 435b.

The static barometer sensor 437 detects or senses air pressure at the fixed location within the hoistway 416 and provides a static air pressure reference to compensate for air pressure changes to the gateway device 434. The gateway device 434 uses the data provided by the static barometer sensor 437 and the dynamic barometer sensor 444 to transform the data into the cabin movement state changes and into cabin movement events, which are in turn transmitted to the cloud-based central data processing service 443 via the mobile wireless interface 435a, 435b.

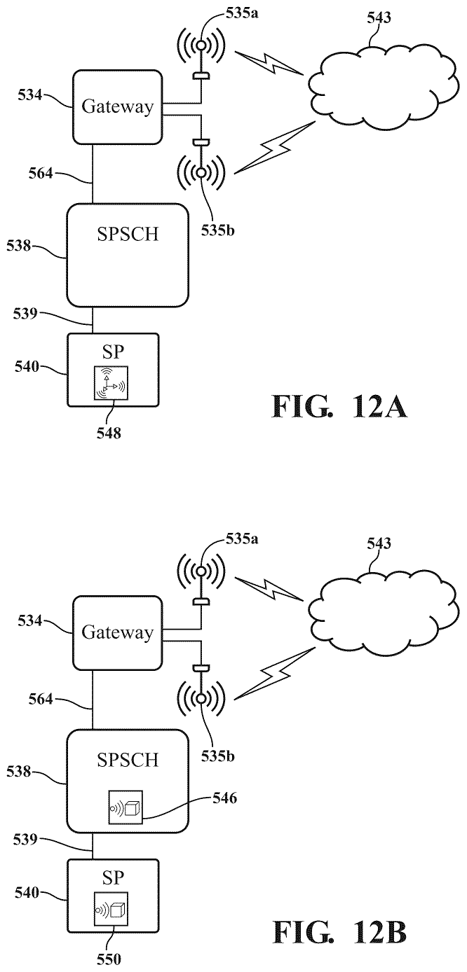

Now referring to FIGS. 11 and 12A-12B, a sixth aspect of an example elevator assembly 510 is schematically depicted. It is understood that the example elevator assembly 510 is similar to the example elevator assembly 310 with the exceptions of the features described herein. As such, like features will use the same reference numerals with a prefix “5” for the reference numbers. As such, for brevity reasons, these features will not be described again.

Referring to FIGS. 11 and 12A, the example elevator assembly 510 may include the gateway device 534 communicatively coupled the signal processing and state computation hub device 538, which in turn is communicatively coupled to the sensor package assembly 540 via the CAN protocol 539. The signal processing and state computation hub device 538 is communicatively coupled to the gateway device 534 via an Ethernet cable interface 564. As such, it should be appreciated the various devices (e.g., the gateway device 534, the signal processing and state computation hub device 538, and the sensor package assembly 540) are each communicatively coupled to one another via wired interfaces and would not necessarily need to be paired to one another as described in greater detail above.

The gateway device 534 may be positioned in the machine room 519 or in the hoistway 516, but is configured to remain stationary. The signal processing and state computation hub device 538 may be positioned on the elevator cab 512, for example, on the cabin roof 515, or on the door header 527 for the door panels 514. The sensor package assembly 540 may be positioned on the elevator cab 512, for example, on the door header 527 for the door panels 514 or on the door panels 514 themselves.

In this aspect, the sensor package assembly 540 may include the accelerometer sensor 548 configured to detect movements of the door panels 514 such as a velocity and/or jerk, thereby determining the dynamic position of the door panels 514. The various sensed, collected, or otherwise obtained data by the sensor package assembly 540 is transmitted to the signal processing and state computation hub device 538 via the CAN protocol 539 as raw data for processing by the signal processing and state computation hub device 538, as discussed in greater detail herein.

Once the signal processing and state computation hub device 538 generates the new data as door movement state changes (e.g., doors stopped, doors moving, door position, doors fully open, doors fully closed), the signal processing and state computation hub device 538 then transmits the door movement state changes data to the gateway device 534 via the Ethernet cable interface 564. The gateway device 534 receives the door movement state changes and assembles and transmits door movement events and/or the cabin movement events to the cloud-based central data processing service 543 via the mobile wireless interface 535a, 535b.

Referring to FIGS. 11 and 12B, the sensor package assembly 540 may include the time of flight sensor 550 configured to detect movements of the door panels 514 as a function of distance changes, thereby determining the dynamic position of the door panels 514. The signal processing and state computation hub device 538 may further include the time of flight sensor 546.

In some embodiments, the signal processing and state computation hub device 538 may be mounted to one end of the door hanger track and uses the time of flight sensor 550 of the sensor package assembly 540 to detect a target 529 on the door panels 314 or the door operator for door movements. In other embodiments, the time of flight sensor 546 of the signal processing and state computation hub device 538 and/or the time of flight sensor 550 of the sensor package assembly 540 detect the movement of the target 529 on the door panels 514 indicative of door movements.

The various sensed, collected, or otherwise obtained data by the sensor package assembly 540 is transmitted to the signal processing and state computation hub device 538 via the CAN protocol 539 as raw data for processing by the signal processing and state computation hub device 538, as discussed in greater detail herein.

Once the signal processing and state computation hub device 538 generates the new data as door movement state changes (e.g., doors stopped, doors moving, door position, doors fully open, doors fully closed), the signal processing and state computation hub device 538 then transmits the door movement state changes data to the gateway device 534 via the Ethernet cable interface 564. The gateway device 534 receives the door movement state changes and assembles and transmits door movement events and/or the cabin movement events to the cloud-based central data processing service 543 via the mobile wireless interface 535a, 535b.

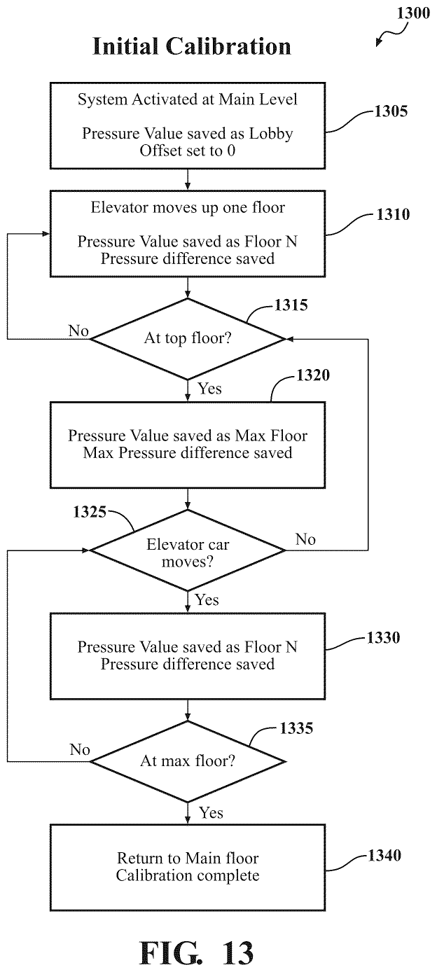

Now referring back to FIGS. 1 and 2A-2C and to FIG. 13, a flow diagram is provided that graphically depicts an illustrative method 1300 for an initial calibration of the various components of the example elevator assembly 10. Although the steps associated with the blocks of FIG. 13 will be described as being separate tasks, in other embodiments, the blocks may be combined or omitted. Further, while the steps associated with the blocks of FIG. 13 will described as being performed in a particular order, in other embodiments, the steps may be performed in a different order.

At block 1305, the example elevator assembly is activated at a main level of the landings and the pressure value is saved as a lobby offset to zero pressure. At block 1310, when the elevator car moves one floor, the pressure value is saved as Floor N and the pressure difference is saved. At block 1315, a determination is made whether the elevator cab is at the top floor. If the elevator cab is not at the top floor, the method 1300 continuously loops between blocks 1310-1315 until the elevator cab is at the top row. When the elevator cab is at the top floor, at block 1315, then the pressure value max is saved as the max floor pressure and the max pressure differential is saved, at block 1320. Another determination is made whether the elevator car has now moved, at block 1325. If the elevator car has not moved, then the method ominously loops between blocks 1315 and 1325 until the elevator cab moves. Once the elevator cab moves, at block 1325, then the pressure value is saved as Floor N and the pressure difference is saved, at block 1330.

Another determination is made whether the elevator cab has now moved back to the top floor, at block 1335. If the elevator cab is not at the top floor, the method 1300 continuously loops between blocks 1325-1335 until the elevator cab is at the top floor. Once at the top floor at block 1335, then the elevator cab is returned to the main floor and the calibration is complete, at block 1340.

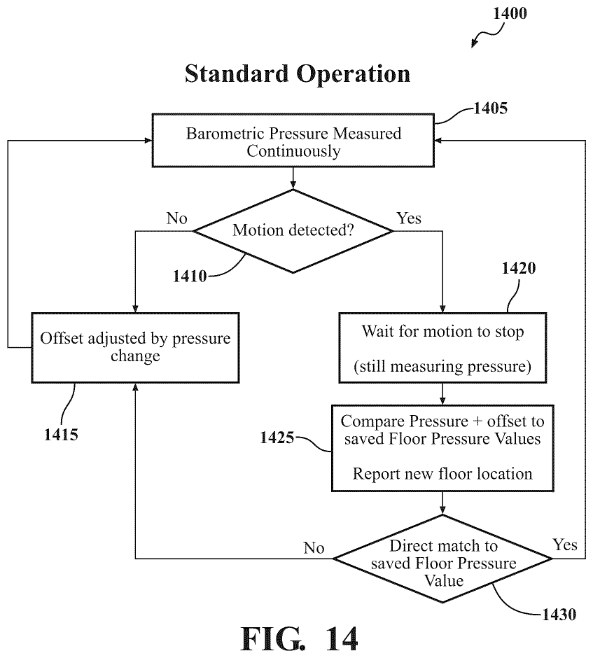

Now referring back to FIGS. 1 and 2A-2C and to FIG. 14, a flow diagram is provided that graphically depicts an illustrative method 1400 for a standard operation using pressure sensing to determine elevator cab location. Although the steps associated with the blocks of FIG. 14 will be described as being separate tasks, in other embodiments, the blocks may be combined or omitted. Further, while the steps associated with the blocks of FIG. 14 will described as being performed in a particular order, in other embodiments, the steps may be performed in a different order.

At block 1405, the static barometric sensor continuously outputs static barometer pressure data to the gateway device for monitoring. A determination is made whether a motion has been detected, at block 1410. When a motion is not detect, then an offset is adjusted by the pressure change, at block 1415, and the method 1400 continuously loops between blocks 1405 and 1415 until a motion is detected. Once a motion is detect at block 1410, then pressure is still monitored until the motion stops, at block 1420. Once the motion has stopped, the pressure and the offset are compared to saved floor pressure values, at block 1425, and the newly landing location is reported. At block 1430, another determination is made as to whether the newly saved floor pressure value is a direct match to a previous saved or recorded pressure value for that floor. If the newly saved floor pressure value is a direct match, then the method 1400 proceeds to block 1405. If the newly saved floor pressure value is not a direct match, then an offset is adjusted by the pressure change, at block 1415, and the method 1400 proceeds to block 1405.

As such, the difference between a new pressure reading and a previous measured pressure reading is calculated (ΔPressure). The pressure at a specified height in the hoistway is known. From the calculated change in pressure, a change in position may be determined. At elevations of buildings that use an elevator, the change in pressure will be linear relative to the change in height (Δ Height) such that Δ Pressure equates to Δ Height.

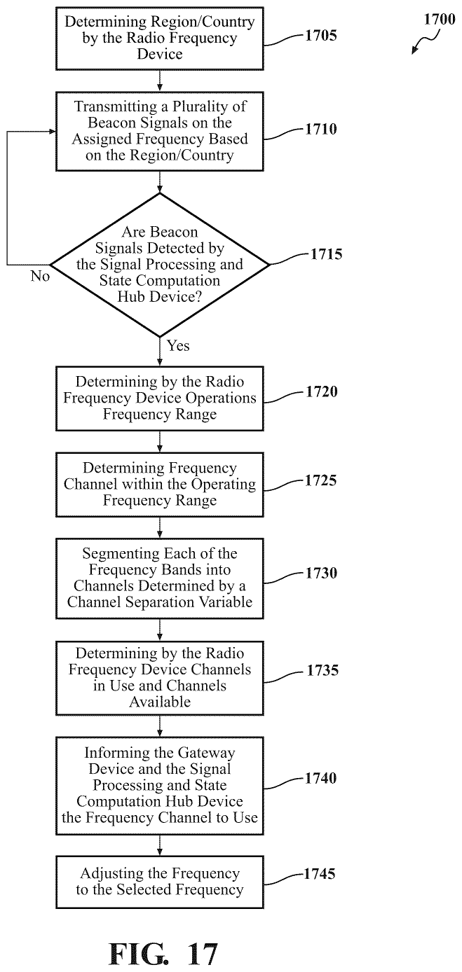

Now referring back to FIGS. 1 and 2A-2C and to FIG. 17, a flow diagram is provided that graphically depicts an illustrative method 1700 for pairing the radio frequency module with the various components of the example elevator assembly 10. Although the steps associated with the blocks of FIG. 17 will be described as being separate tasks, in other embodiments, the blocks may be combined or omitted. Further, while the steps associated with the blocks of FIG. 17 will described as being performed in a particular order, in other embodiments, the steps may be performed in a different order.

At block 1705, the radio frequency module determines the region/country of the placement within the example elevator assembly. It should be appreciated that various regions and/or countries may have different frequency bands available for use. As such, the radio frequency module is dynamically configured for the region/country of the installation. At block 1710 the radio frequency module transmits beacon messages on an assigned frequency within that country frequency range. The signal processing and state computation hub device alternately listens on two different frequencies to detect the beacon transmission at block 1715. If the beacon transmissions are not detected by the processing and state computation hub device blocks 1710-1715 continuously loop. One the processing and state computation hub device detects the beacon transmission at block 1715, then the radio frequency module determines the operating frequency range for the installation, at block 1720.

In response, once the operating frequency range is determined, the pairing mechanism employed by the gateway device, the radio frequency module, and the processing and state computation hub device automatically determines the frequency channel within the country frequency range that will be used as the operating frequency, at block 1725. At block 1730, the pairing mechanism segments each of the globally administered frequency bands into a number of channels, the total of which is determined by a channel separation variable, with each channel occupied by a single gateway device, radio frequency module, and the processing and state computation hub device combination. The radio frequency module then determines which frequency channels are already in use by other devices and selects an available channel for the radio frequency module to use for this installation, at block 1735. The desired processing and state computation hub device is selected for pairing by the user and at the end of the pairing process, the radio frequency module informs the processing and state computation hub device which frequency channel normal communications will be used, at block 1740. After the pairing process is complete, both the radio frequency module and the processing and state computation hub device adjust their operating frequency to the selected frequency channel and begin normal communications, at block 1745.

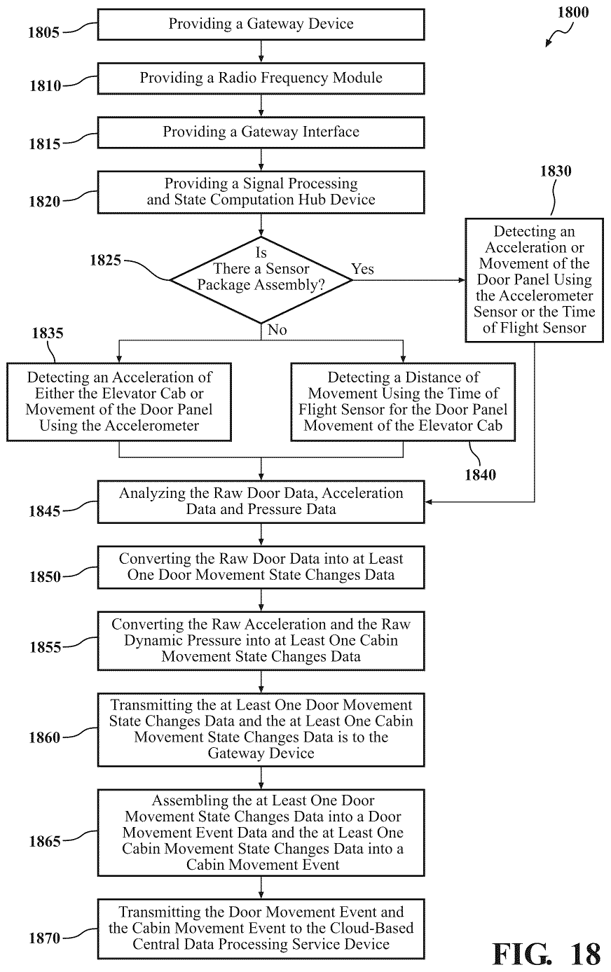

Now referring back to FIGS. 1 and 2A and to FIG. 18, a flow diagram is provided that graphically depicts an illustrative method 1800 for remotely monitoring the elevator cab position and door panels position using the various components of the example elevator assembly 10. Although the steps associated with the blocks of FIG. 18 will be described as being separate tasks, in other embodiments, the blocks may be combined or omitted. Further, while the steps associated with the blocks of FIG. 18 will described as being performed in a particular order, in other embodiments, the steps may be performed in a different order.

At block 1805, a gateway device having a processor is provided in the hoistway or in a machine room of the example elevator assembly. The gateway device includes a cloud orientated wireless interface that is configured to transmit data to a cloud-based central data processing service device. At block 1810, optionally, a radio frequency module may be provided. The radio frequency module includes a static barometer in the hoistway and communicatively coupled to the gateway. The static barometer providing a raw static pressure of the hoistway. At block 1815, optionally, a gateway interface may be provided in the hoistway that is communicatively coupled to the radio frequency module. In some embodiments, the gateway interface may be a wireless interface. In other embodiments, the gateway interface may be a wired interface using Ethernet.

At block 1820, optionally, a signal processing and state computation hub device may be provided and coupled to the elevator cab. It should be understood that the signal processing and state computation hub device may be integrated or incorporated into the gateway device 34 known herein as the signal processing and state computation hub device library. The signal processing and state computation hub device may include a dynamic barometer and an accelerometer or a time of flight sensor. The signal processing and state computation hub is communicatively coupled to the wireless interface. In some embodiments, the signal processing and state computation hub device includes both the accelerometer sensor and the time of flight sensor. At block 1825, a decision is made as to whether there is a sensor package assembly. If there is a sensor package assembly determined at block 1825, then, at block 1830, an acceleration or movement of the door panel using the accelerometer or the time of flight sensor is detected. If there is not a sensor package assembly determined at block 1825, then at block 1835, an acceleration of either the elevator cab or movement of the door panel using the accelerometer is detected or sensed. Alternatively, or in addition, at block 1840, a distance of movement using the time of flight sensor for the door panel movement of the elevator cab is detected or sensed.

At block 1845, the signal processing and state computation hub device analyzes the raw door data and converts the raw door data into at least one door movement state changes data, at block 1850. At block 1855, the signal processing and state computation hub device analyzes and converts the raw acceleration and the raw dynamic pressure into at least one cabin movement state changes data. At block 1860, the at least one door movement state changes data and the at least one cabin movement state changes data is transmitted to the gateway device via a transmitter of the signal processing and state computation hub device to the gateway interface.

At block 1865, the gateway device assemblies the at least one door movement state changes data into a door movement event and the at least one cabin movement state changes data into a cabin movement event, and at block 1870, transmits the door movement event and the cabin movement event to the cloud-based central data processing service device via the mobile wireless interface.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for remotely determining a vertical position of an elevator cab and an elevator door movement of a door panel of the elevator cab in a hoistway, the method comprising the steps of:
providing a gateway device having a processor in the hoistway or in a machine room, the gateway device having a mobile wireless interface that is configured to transmit data to a cloud-based central data processing service device;
providing a radio frequency module having a static barometer in the hoistway and communicatively coupled to the gateway device, the static barometer providing a raw static pressure;
providing a gateway interface in the hoistway that is communicatively coupled to the radio frequency module;
providing the elevator cab positioned in the hoistway;
providing a signal processing and state computation hub device coupled to the elevator cab, the signal processing and state computation hub device including a dynamic barometer sensor and an accelerometer sensor or a time of flight sensor, the signal processing and state computation hub communicatively coupled to the gateway interface;
measuring an acceleration data using the accelerometer sensor or a distance of movement of the door panel using the time of flight sensor for the elevator door movement of the elevator cab as a raw door data and a dynamic pressure from the dynamic barometer sensor as a raw dynamic pressure;
converting the raw door data into at least one door movement state changes data;
converting the acceleration data and the raw dynamic pressure into at least one cabin movement state changes data;
transmitting the at least one door movement state changes data and the at least one cabin movement state changes data to the gateway device via the gateway interface;
assembling the at least one door movement state changes data into a door movement event and the at least one cabin movement state changes data into a cabin movement event; and
transmitting the door movement event and the cabin movement event to the cloud-based central data processing service device via the mobile wireless interface.

2. The method of claim 1, wherein the at least one cabin movement state changes data corresponds to the vertical position of the elevator cab in the hoistway.

3. The method of claim 1, wherein the gateway interface and a transmitter of the signal processing and state computation hub device communicate via a sub gigahertz frequency.

4. The method of claim 1, further comprising:
transmitting, by the radio frequency module, a plurality of beacon messages on an assigned frequency;
detecting, by the signal processing and state computation hub device, the plurality of beacon messages;
determining an operating frequency range;
determining a frequency channel within the operating frequency range by segmenting each into channels determined by a channel separation variable;
determine available channels;
selecting a channel and instructing the gateway device and the signal processing and state computation hub device the channel.

5. The method of claim 1, further comprising:
providing a sensor package assembly communicatively coupled to the signal processing and state computation hub device, the sensor package assembly having the accelerometer sensor configured to measure the elevator door movement of the elevator cab as the raw door data; and
transmitting the raw door data to the signal processing and state computation hub device.

6. The method of claim 1, further comprising:
providing a sensor package assembly mounted to the elevator cab and communicatively coupled to the signal processing and state computation hub device, the sensor package assembly having:
a second accelerometer configured to measure the acceleration data for the elevator door movement of the elevator cab as the raw door data; and
the time of flight sensor configured to detect the distance of movement for the elevator door movement of the elevator cab as a raw door distance data;
transmitting the raw door data and the raw door distance data to the signal processing and state computation hub device.

7. The method of claim 6, further comprising:
converting the raw door data into the at least one door movement state changes data; and
transmitting the at least one door movement state changes data and the raw dynamic pressure to the gateway device via the gateway interface.

8. A method for remotely determining a vertical position of an elevator cab and an elevator door movement of a door panel of the elevator cab in a hoistway, the method comprising the steps of:
providing the elevator cab positioned in the hoistway;
providing a gateway device coupled to the elevator cab, the gateway device having a processor, a signal processing and state computation hub device library, and a mobile wireless interface that is configured to transmit data to a cloud-based central data processing service device;
providing a sensor package assembly attached to the elevator cab, the sensor package assembly having an accelerometer sensor, the sensor package assembly communicatively coupled to the gateway device;
measuring an acceleration of a movement of the door panel using the accelerometer sensor as a raw door data;
converting the raw door data into at least one door movement state changes data;
assembling the at least one door movement state changes data into a door movement event; and
transmitting the door movement event to the cloud-based central data processing service device via the mobile wireless interface.

9. The method of claim 8, wherein the sensor package assembly further comprising:
a time of flight sensor,
wherein the accelerometer sensor is configured to sense a movement of the elevator cab and the time of flight sensor is configured to sense movement of the door panel via a change in distance between a target and the time of flight sensor.

10. The method of claim 9, further comprising:
providing a dynamic radio frequency module having a dynamic barometer sensor and positioned on the elevator cab, the dynamic radio frequency module communicatively coupled to the gateway device, the dynamic barometer sensor configured to detect a pressure at the elevator cab.

11. The method of claim 10 further comprising:
measuring a distance of movement using the time of flight sensor for the elevator door movement of the elevator cab as a raw door distance data;
measuring a raw dynamic pressure detected by the dynamic barometer sensor and raw acceleration data detected by the accelerator sensor indicative of cabin movements;
converting the acceleration data and the raw dynamic pressure into at least one cabin movement state changes data;
converting the raw door distance data into the at least one door movement state changes data;
assembling the at least one door movement state changes data into the door movement event and the at least one cabin movement state changes data into a cabin movement event; and
transmitting the door movement event and the cabin movement event to the cloud-based central data processing service device via the mobile wireless interface.

12. The method of claim 11, further comprising:
providing a gateway interface in the hoistway that is communicatively coupled to the gateway device;
providing a radio frequency module having a static barometer in the hoistway and communicatively coupled to the gateway interface, the static barometer providing a raw static pressure;
comparing changes between the raw dynamic pressure and the raw static pressure by the gateway device;
converting the changes between the raw dynamic pressure and the raw static pressure into the at least one cabin movement state changes data of the elevator cab; and
assembling the at least one cabin movement state changes data into the cabin movement event; and
transmitting the door movement event and the cabin movement event to the cloud-based central data processing service device via the mobile wireless interface.

13. The method of claim 12, further comprising:
transmitting, by the radio frequency module, a plurality of beacon messages on an assigned frequency;
detecting, by the signal processing and state computation hub device, the plurality of beacon messages;
determining an operating frequency range;
determining a frequency channel within the operating frequency range by segmenting each into channels determined by a channel separation variable;
determine available channels;
selecting a channel and instructing the gateway device and the signal processing and state computation hub device the channel.

14. An elevator system for remotely determining a vertical position of an elevator cab and an elevator door movement of a door panel of the elevator cab in a hoistway, the elevator system comprising:
a sensor package assembly having an accelerometer sensor mounted to the elevator cab;
a radio frequency module having a static barometer in the hoistway;
a gateway device communicatively coupled to the radio frequency module;
a signal processing and state computation hub device coupled to the elevator cab and communicatively coupled to the sensor package assembly and to the gateway device, the signal processing and state computation hub device including a dynamic barometer sensor and a second accelerometer sensor, the signal processing and state computation hub device further having a processor and a non-transitory, processor-readable storage medium in communication with the processor comprising one or more programming instructions that, when executed, cause the processor to:
measure an acceleration of the door panel as a raw door data using the accelerometer sensor, a dynamic pressure from the dynamic barometer sensor as a raw dynamic pressure and a cabin acceleration data detected from the second accelerometer sensor;
convert the raw door data into at least one door movement state changes data;
convert the cabin acceleration data and the raw dynamic pressure into at least one cabin movement state changes data; and
transmit the at least one door movement state changes data and the at least one cabin movement state changes data to the gateway device,
wherein the gateway device includes a gateway processing device and a gateway non-transitory, processor-readable storage medium in communication with the processor and comprising one or more programming instructions that, when executed, cause the gateway processing device to:
assemble the at least one door movement state changes data into a door movement event and the at least one cabin movement state changes data into a cabin movement event; and
transmit the door movement event and the cabin movement event to a cloud-based central data processing service device via a mobile wireless interface.

15. The elevator system of claim 14, further comprising
a time of flight sensor mounted to the elevator cab and configured to sense a change in a distance between a target and the time of flight sensor indicative of the movement of the door panel.

16. The elevator system of claim 15, wherein the radio frequency module is communicatively coupled to the gateway device via a universal serial bus cable interface.

17. The elevator system of claim 16, wherein the sensor package assembly is communicatively coupled to the signal processing and state computation hub device via a controller area network communication protocol.

18. The elevator system of claim 14, wherein a gateway interface is positioned within the hoistway and is communicatively coupled to the radio frequency module and to the signal processing and state computation hub device.

19. The elevator system of claim 18, wherein the gateway interface is a wireless communication protocol between the radio frequency module and the signal processing and state computation hub device.

20. The elevator system of claim 18, wherein the gateway interface is a wired communication protocol utilizing Ethernet between the radio frequency module and the signal processing and state computation hub device.
